(19) United States
(12) Patent Application Publication
(10) Pub. No.: US 2005/0177661 A1
(43) Pub. Date: Aug. 11, 2005

(54) Multimedia playback device with a USB controller

(76) Inventor: Fok Kei Loo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/774,513

(22) Filed: Feb. 10, 2004

(51) Int. Cl. G06F 13/12

(52) U.S. Cl. 710/72

(57) ABSTRACT

A multimedia playback device with USB controller has a digital camera module, a MP3 player module, a first controller connected to the digital camera module and the MP3 player module for controlling a digital signal, a second controller connected to the first controller for accessing the data in the USB memory device, and a USB interface connected to the second controller for connecting an external USB memory device. The second controller in the present invention can directly access the external USB memory device.

### FIELD OF THE INVENTION

The present invention relates to a multimedia playback device with a USB controller, and especially to a multimedia playback device that can connect and access a USB memory device.

### BACKGROUND OF THE INVENTION

In this digital era, there are various kinds of digital products, such as powerful personal computers, portable personal digital assistants (PDA), digital still cameras (DSC) for taking a photo and instantly viewing the taken photo, and mobile phones for mobile communication or scanners for converting paper documents into electronic files. These products have one thing in common, that is, the data is all stored in digital format, which can be stored long-term, repeatedly read or otherwise used.

With the popularity of personal computers, integration of digital cameras and MP3 players with computers is also required. The demand for digital cameras has increased, and the digital camera has become the most attractive computer peripheral device. The digital camera usually uses a light sensitization element such as charge-coupled device (CCD) or complementary metal-oxide semiconductor (CMOS) sensor to transform optical image data into an electrical signal. The electrical signal is processed through a digital signal processor (DSP), a JPEG image process, and data compression, and then is stored in memory.

MP3 (MPEG Audio Layer3) is a low-distortion data compression technique. This technique use a special data compression algorithm to process audio signals. The digital audio document size after MP3 compression is one tenth of the original data size, while the quality of the audio signal is almost the same as CD audio quality. Thus, the MP3 player is the most popular audio player today.

The USB flash disk (also known as thumb driver) using a USB transmission interface has become a necessity for data backup. Its capacity is much greater than that of a than floppy diskette and it can be used in multimedia applications, such as MP3 recording and digital camera image data backup.

Digital camera and MP3 player transmissions in the prior art uses a master-slave architecture controlled by a host computer. The transmission and reception of data must be controlled by and through the computer. The USB flash disk is still controlled by the computer, too, and cannot be directly accessed by a digital camera or MP3 player.

### SUMMARY OF THE INVENTION

It is an object of the present invention to provide a multimedia playback device with a USB controller, whereby a USB flash disk can be connected to and accessed by the multimedia playback device of the present invention.

To achieve the object mentioned above, the present invention provides a digital camera and MP3 player device with a USB controller, which comprises a digital camera module, a MP3 player module, a first controller connected to the digital camera module and the MP3 player module to control digital signal, a second controller connected to the first controller to access the data in the USB memory device, and a USB interface connected to the second controller for linking the outside USB memory device. The present invention can connect the USB memory device and access the data in it.

### BRIEF DESCRIPTION OF DRAWINGS

The various objects and advantages of the present invention will be more readily understood from the following detailed description when read in conjunction with the appended drawing, in which:

FIG. 1 shows a three-dimensional picture according to a preferred embodiment of the present invention connected to a USB memory device;

FIG. 2 shows a circuit block diagram of the present invention;

FIG. 3 shows a circuit block diagram of the digital camera module; and

FIG. 4 shows a circuit block diagram of the MP3 player module.

### DETAILED DESCRIPTION OF THE INVENTION

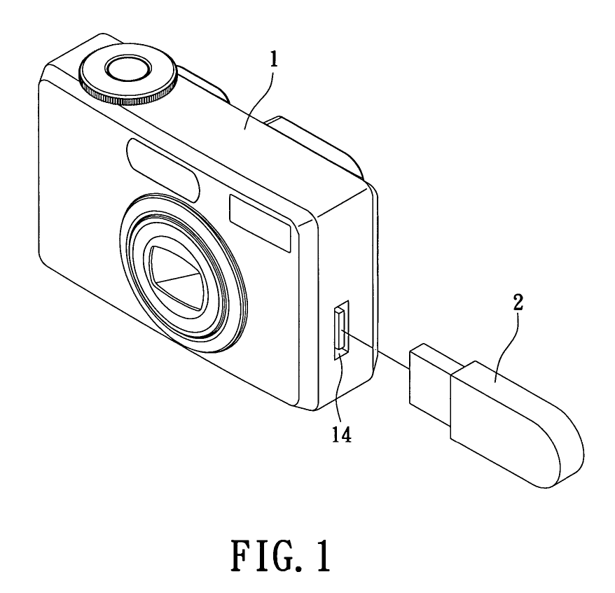

FIG. 1 shows a perspective view of a multimedia playback device 1 with a USB controller according to the present invention. The multimedia playback device 1 is connected to a USB memory device 2 through a USB interface 14 thereof. The USB memory device 2 is, for example, a USB flash disk.

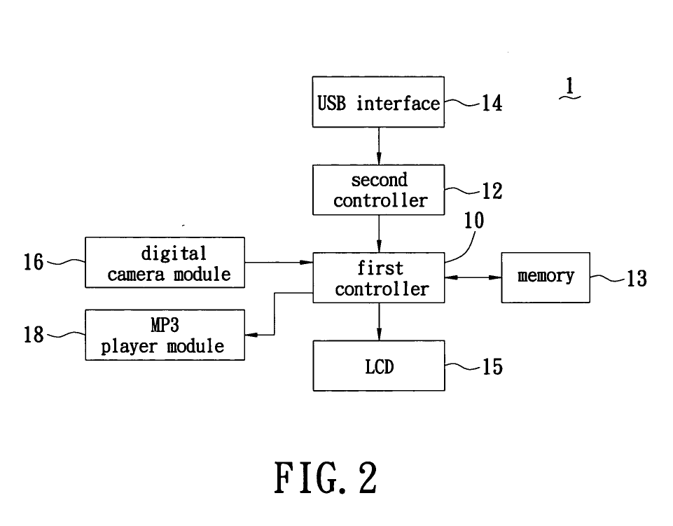

FIG. 2 shows a block diagram of the multimedia playback device 1 according to the preferred embodiment of the present invention. The multimedia playback device 1 integrates the function of the digital camera and the MP3 player and comprises a first controller 10, a second controller 12, a memory 13, a USB interface 14, an LCD 15, a digital camera module 16 and a MP3 player module 18.

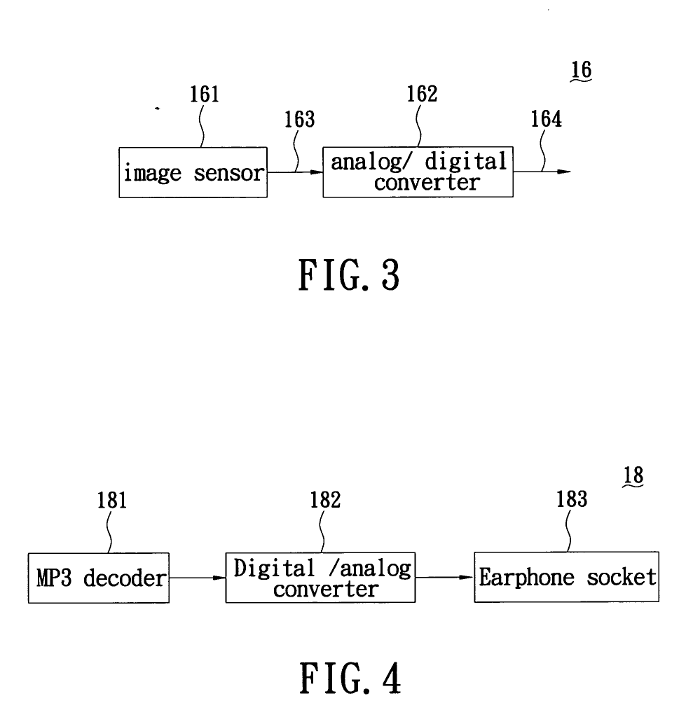

With reference also to FIG. 2, FIG. 3 is a circuit block diagram of the digital camera module 16. The digital camera module 16 comprises an image sensor 161 and an analog/digital converter 162. The image sensor 161 senses an optical image, and transforms the optical image into an analog image signal 163. The analog/digital converter 162 then transforms the analog image signal 163 into a digital image signal 164, i.e., a digital camera digital image file. The digital image file will be stored in the memory 13 through the control of the first controller 10. The memory 13 can be a flash memory. A user can use the LCD 15 to watch the image captured by the image sensor when the image sensor is working.

With reference also to FIG. 2 FIG. 4 is a circuit block diagram of MP3 player module 18. The MP3 player module 18 comprises an MP3 decoder 181, a digital/analog converter 182 and an earphone socket 183. The MP3 decoder 181 is controlled by the first controller 10 to decode an MP3 audio files stored in the memory 13, and transfers the audio signal to the digital/analog converter 182. The digital/analog converter 182 converts the data type of the audio signal. Then the MP3 player module 18 transfers the audio signal to an earphone through the earphone socket 183 into which the earphone is. Therefore, audio sound can be heard through the earphone.

Referring again to FIG. 2, the second controller 12 is connected the first controller 10 and the USB interface 14, and can be a USB 2.0 OTG controller. The second controller 12 is controlled by the first controller 10 to access the USB memory device 2 which is connected to the USB interface 14 (see FIG. 1). Therefore, the MP3 audio files or the digital camera image data in the USB memory device 2 can be stored in the memory 13 of the present invention. The second controller 12 can also be controlled by the first controller 10 to transfer the MP3 audio files and the graph data of digital camera stored in the memory 13 to the external memory device 2 (see FIG. 1). Therefore, the multimedia playback device 1 according to the present invention can directly access the external memory device 2 without using a host computer.

As mentioned above, the second controller 12 controls the access to the external USB memory device 2 through the USB interface 14 without going through a host computer. This is more convenient and quicker.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the scope of the invention as defined in the appended claims.

1. A multimedia playback device with a USB controller, for connection of an external USB memory device thereto, comprising:
a digital camera module used to capture an image;
an MP3 player module used to process and playback an audio signal;
a first controller connected to the digital camera module and the MP3 player module to control and process a digital signal;
a second controller connected to the first controller and used to control access of the USB memory device; and
a USB interface connected to the second controller and the USB memory device.

2. The multimedia playback device with a USB controller as in claim 1, further comprising a memory to connected to the first controller and used to store data.

3. The multimedia playback device with USB controller as in claim 1, further comprising a liquid crystal display connected to the first controller and used to show a data message.

4. The multimedia playback device with USB controller as in claim 1, wherein the digital camera module comprises:
an image sensing element used to capture the image and produce an analog image signal; and
an analog/digital converter connected to the image sense element and used to convert the analog image signal into a digital image signal.

5. The multimedia playback device with USB controller as in claim 1, wherein the MP3 player module comprises:
an MP3 decoder;
a digital/analog converter connected to the MP3 decoder and used to convert a data type of signal from the MP3 decoder; and
an earphone socket connected to the digital/analog converter for connection of an external earphone thereto.

6. The multimedia playback device with USB controller as in claim 1, wherein the second controller is one of a USB 2.0 compliance host controller and an OTG controller.
